(19) United States
(12) Patent Application Publication
(10) Pub. No.: US 2018/0073829 A1
(43) Pub. Date: Mar. 15, 2018

(54) Battlefield Simulation Adapter

(71) Applicant: Michael Palazzi, Mountain Lakes, NJ (US)

(72) Inventor: Michael Palazzi, Mountain Lakes, NJ (US)

(21) Appl. No.: 14/542,650

(22) Filed: Nov. 16, 2014

Related U.S. Application Data
(63) Continuation-in-part of application No. 13/936,677, filed on Jul. 8, 2013, now abandoned.

(51) Int. Cl. F41A 33/04; G09B 9/00; F42B 8/02

(52) U.S. Cl. CPC F41A 33/04; F41A 19/58; F42B 8/02; G09B 9/003

(57) ABSTRACT

The present invention is a battlefield simulation support system, possessing one or more adapters that permit the simulation support system to fire a variety of cartridges with varying electrical and control characteristics. The adapters can be mated with a main body that accepts control inputs and distributes them to a plurality of firing mechanisms.

### RELATED APPLICATIONS

This application is a Continuation-in-Part of U.S. patent application Ser. No. 13/936,677 filed Jul. 8, 2013, which is included here by reference.

### FIELD OF THE INVENTION

This invention relates to the fields of battlefield simulation equipment, electronic battlefield simulators, and electronic control of explosive devices.

### BACKGROUND OF THE INVENTION

In the field of battlefield simulation, prior art systems ignite energetic, explosive cartridges containing gunpowder or other explosives to creating non-lethal concussions, with or without smoke, that are used in training situations.

Said cartridges may have a plurality of functions and triggering mechanisms. Functions include loud noise, colored smoke or other visual warnings, and other unique features.

The cartridges are ignited via electrical excitation The type of excitation varies depending on the cartridge type that is used.

While cartridges may have different attributes, such as noise level, smoke level, and light output, the attributes still share common means of ignition, to avoid duplicative separate trigger mechanisms.

Presently, said cartridges are not of a common construction, requiring different equipment to ignite different classes of cartridges. The difference is primarily one of an electrical nature.

The present invention provides adaptation such that an existing trigger box can be used with a cartridge not designed or capable of being ignited by said un-assisted trigger box.

Typical Commercially available systems are comprised of a trigger control unit, which contains the necessary controls to the operator to provide the proper sequence and means to trigger the pyrotechnic display desired. The trigger box also provides the required electrical or electronic controls to provide the proper safety measures and power output to trigger the energetic cartridge which resides in a holder which can safely contain the cartridge through the firing sequence.

Various configurations of these trigger/cartridge holding systems can be made. Some can be remotely fired via external triggers, others can use proximity or electric ‘eye’, wireless and other radio controlled means. Yet others can be networked together.

Common to these platforms is the use of energetic material, usually made of some form of gunpowder but not restricted to such, that is in a self-contained cartridge for safe handling and loading.

These cartridges have further safety measures to contain an internal fuse mechanism that requires purposeful application of external power, such that casual contact with the cartridge does not ignite them.

Not all cartridges have the same type of fuse and therefore various cartridges may require various means to ignite. In addition, cartridges may be of different sizes, shapes and electrical connection means.

Adaptation may extend beyond just pyrotechnic cartridges. The addition of light emission or sound reproduction could be realized by using the same means of adaptation and the use of alternate electronic circuits, mechanical sirens, electronic file playback, smoke generators, pressurized gas controlled release.

### Types of Existing Cartridge Excitations on the Market Today:

### Amperage Based:

Cartridge types, such as M30 have an internal fuse that requires amperage to ignite at a low voltage, typically 12 volts.

### High Voltage Based:

Cartridge types such as M34 are available and require a high voltage trigger, usually in excess of 15 Kv, to ignite. Although such high voltages are required, the trigger control units typically run off of a 12 volt source.

### BRIEF SUMMARY OF THE INVENTION

The present invention is an adapter that can be connected to an existing battlefield simulation system. The purpose of the present invention is to provide both mechanical and electrical conversion such that a foreign cartridge not designed to be used by a particular trigger system can be placed in the adapter and the adapter will accept the existing trigger system signals and provide a secure mounting and electrical conversion to ignite the foreign cartridge.

The present invention is a self-contained adapter that can be fired without any further conversion, control or signaling by simply applying power.

The present invention allows adapters that do the same function to be mounted or placed near one another.

The present invention allows a single unit capable of holding multiple cartridges that can be fired simply by applying power.

The present invention provides a means to attach various cartridges to an existing system which was not originally designed for said cartridge, and safely ignite them using the existing equipment.

### BRIEF DESCRIPTION OF THE SEVERAL VIEWS OF THE DRAWINGS

FIG. 1: Profiles of native cartridge and foreign cartridges.

FIG. 2: Cross-section of a native cartridge contained in a native holder and with integrated base unit attachment.

FIG. 3: Cross-section of IMGO holder and base unit attachment.

FIG. 4: Top view of cavity with further example of possible high voltage separation considerations and possible electrical connections.

FIG. 5: Block diagram with one embodiment of conversion electronics.

FIG. 6A. Side Perspective view of preferred embodiment

FIG. 6B. Top Perspective view of preferred embodiment

### DETAILED DESCRIPTION

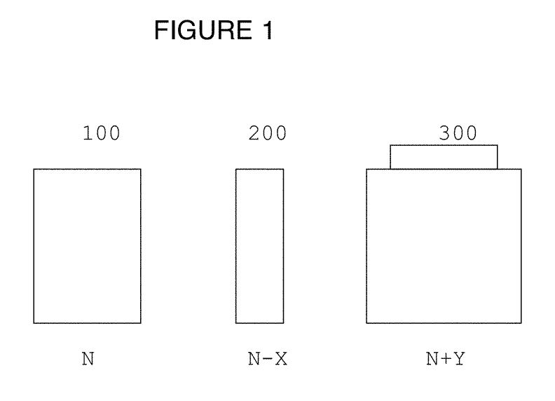

The present invention is a self-contained adapter, which can hold multiple signaling cartridges, utilizing existing trigger signals. With or without any further power source or controls, the present invention is able to regenerate the incoming trigger signal and convert it to be able to fire a foreign cartridge. In FIG. 1, native cartridge 100 is one for which the original trigger mechanism was designed. N represents the diameter of the native cartridge. Y 200 and X 300 indicate differences in the diameter of the foreign cartridges.

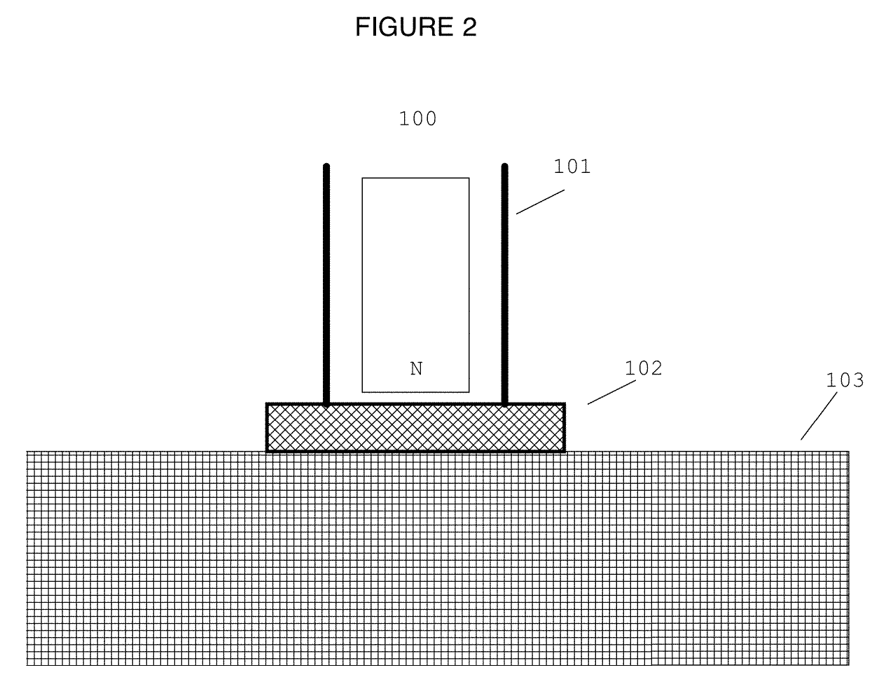

FIG. 2 is an example of a native cartridge 100 contained in a native holder 101 and with integrated base unit attachment 102. This diagram shows one example of how an existing system is constructed. The entire native holder 101,102 attaches to the native base 103.

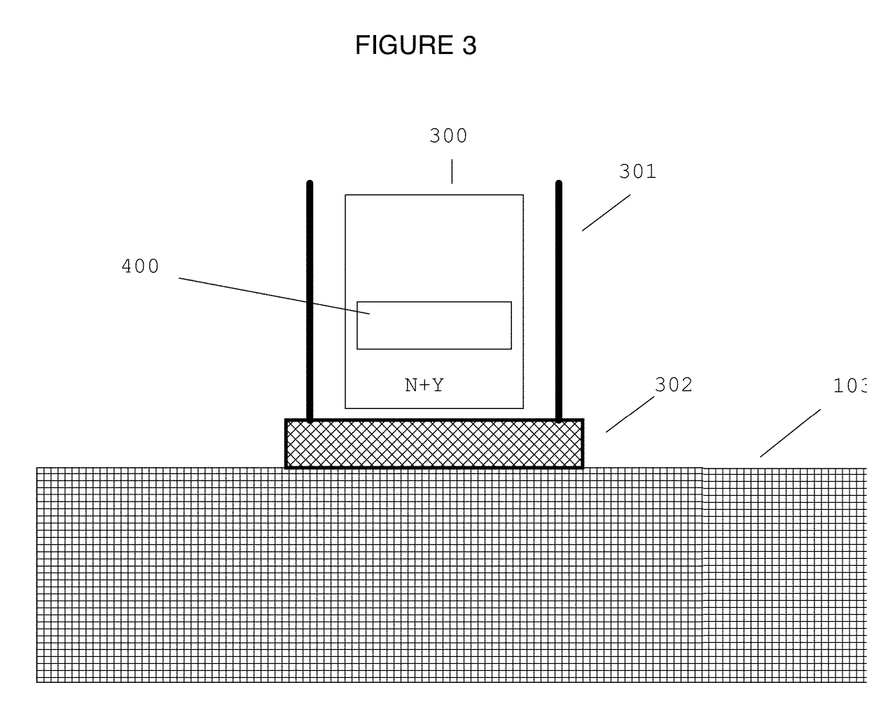

FIG. 3 is an example of the preferred embodiment holder and base unit attachment. This diagram shows an outline of the adapter 301, 302 containing a foreign cartridge 300 and how it attaches to the native base unit 103. Item 400 shows the unique cavity for housing the electrical conversion circuits which can also contain high voltage separation considerations.

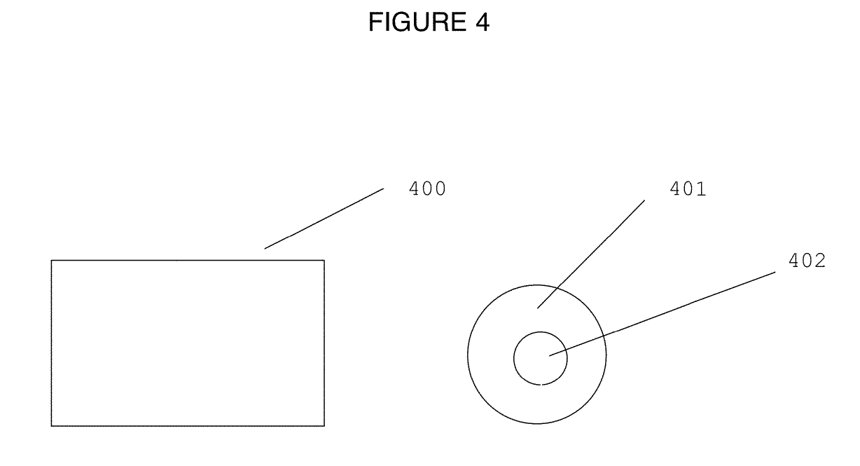

FIG. 4 shows cavity 400 with further example of possible high voltage separation considerations and possible electrical connections. Items 401 and 402 show possible high voltage feed with item 402 showing a metal, carbon or other conductive core surrounded by 401 insulating ring. There are both electrical and mechanical considerations in providing a universal adapter that can provide attachment to an existing system both electrically and/or mechanically. The present invention's attachment means can be made to physically accept the mounting provisions of existing firing mechanisms or stand-alone as an adjunct to the same via an adapter plate.

There are electronic incompatibilities among the firing fuses of various cartridges, as discussed above, and the present invention has self-contained electronic circuitry that converts the incoming fuse firing energy to the proper form to support the particular cartridge being utilized. These electronics are housed in the present invention's main body section.

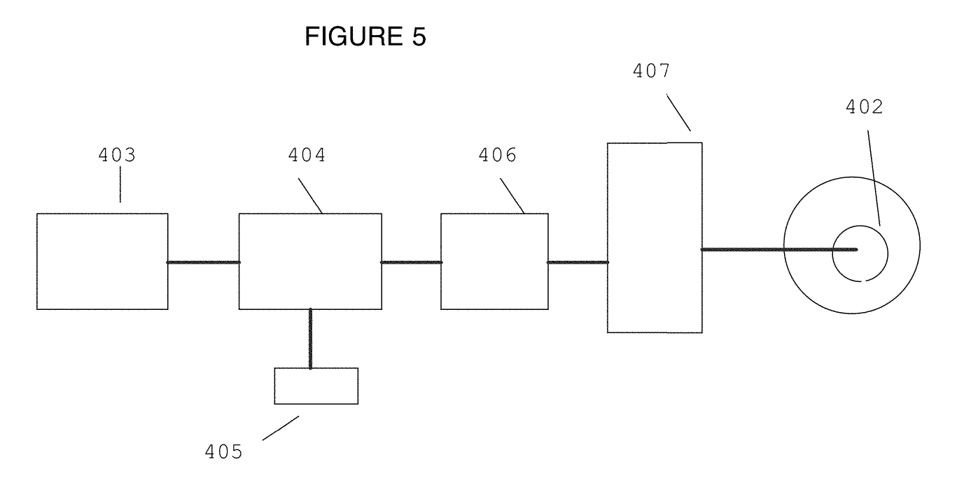

A simple example of such conversion is shown in FIG. 5. Note that once again, specific electronic elements are implemented to support such conversion and as such are or may be different for the various types fuses used in the cartridge.

FIG. 5 is a block diagram showing the preferred method of conversion electronics 403 containing physical electrical connection and optional input filtering. Item 404 is an internal oscillator with adjustment controls 405 set at manufacturing time to optimize the power use feeding high current drive circuits 406 with voltage protection means driving high voltage transformer 407 with secondary output feeding high voltage isolator 402.

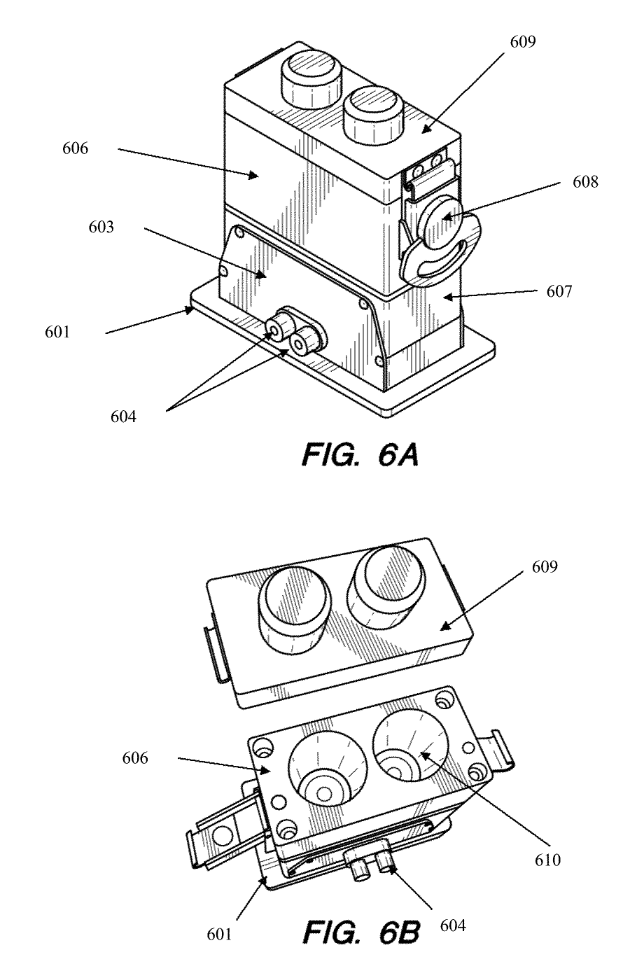

FIG. 6 shows a typical assembled invention. The assembly is comprised of an adapter plate 601, an inspection port above the adapter plate 601, and above the external electrical connection 604. The inspection plate 603 covering the inspection port is held with 4 small screws.

The cartridge holder body 606 sits above the main body 607, which contains two side clamps 608. There are a plurality of cartridge slots 610 within the holder body 606 to accommodate a variety of cartridges. The cartridge holder 609 covers the holder body 606. The figure is a single example of many possible adapters.

Other physical considerations include the cartridge containment and holder. The present invention must be able to physically accommodate the types of cartridges to be used and must also be able to provide electrical connections to them. The present invention provides this feature by having removable cartridge holders which can be replaced by various other holders, each specifically designed for the desired cartridge.

To aid in the adaptation of the various cartridge holders, an intermediary plate can be utilized to accommodate differences such as height, width as well as to provide a means to hold electrical connections between the cartridge holder and the main body section of the present invention.

Electrical connection are made via the external electrical connector 604 provided on the sides of the device's main body 607, as in FIG. 6. These connections can be further modified by using one of a plurality of connectors or an electrical converter cable that provides translation from the device connector to the target cartridge.

The present invention is a self-contained adapter which fits in form to an existing fixture, utilizes existing trigger signals, and without any further power source or controls, is able to regenerate the incoming trigger signal and convert it to be able to fire a foreign cartridge.

As an optional additional embodiment of the invention, it is possible to use an additional local power source that connects to the invention, and then the invention would use the trigger from the current device to fire. The present invention would be connected to the existing firing system. This would cover those circumstances where the current firing system would not be able to provide enough energy to fire a foreign cartridge, and this method would allow users to do so.

As another optional embodiment, using the external power adaptation provided by the present invention, a trigger signal designed for firing a single or fixed number of cartridges could be expanded to provide for the firing of a virtually unlimited number of cartridges off of that same trigger.

Although the invention has been described and illustrated with respect to exemplary embodiments thereof, it should be understood by those skilled in the art that the foregoing and various other changes, omissions, and additions may be made therein and thereto, without parting from the spirit and scope of the present invention.

What is claimed is:

1. A battlefield simulation adapter, the adapter comprised of an adapter plate, a main body, a cartridge holder body, a cartridge holder, and a plurality of cartridges,
the main body resting on the adapter plate, the main body possessing an inspection port on the side of the main body and an external electrical connection above the adapter plate and above the external electrical connection, the inspection port covered completely by an inspection plate,
the cartridge holder body sitting above the main body, the cartridge holder body possessing a plurality of cartridge slots in its upper surface, the cartridge holder body optionally resting on an intermediary plate between the main body and itself, the intermediary plate capable of adjusting the adapter to various sized cartridge holder bodies and to their various electrical characteristics,
the cartridge holder covering the cartridge holder body upper surface completely, the cartridge holder body possessing two side clamps, one on each side of the cartridge holder body, said side clamps positioned to hold the cartridge holder down removably onto the upper surface of the cartridge holder body,
said cartridge slots selected from a range of physical sizes and electrical voltage/amperage characteristics such that cartridges inserted in said cartridge slots are capable of being powered and controlled by control signals sent to the adapter, said control signals entering the adapter via the external electrical connection,
the main body possessing conversion electronics that aid in converting electrical characteristics from control signals and power input to the main body into control and power input capable of firing cartridges held in the cartridge holder body.

2. The battlefield simulation adapter of claim 1, where the conversion electronics are physical electrical connections and input filtering comprised of an internal oscillator with adjustment controls set at manufacturing time to optimize the power use, said power feeding high current drive circuits with a voltage protection means driving a high voltage transformer with secondary output, said transformer feeding a high voltage isolator.

3. The battlefield simulation adapter of claim 1 where the cartridges are selected from the list of amperage based and high voltage based, said amperage based cartridges similar to the M30 cartridge, said high voltage based cartridges similar to the M34, requiring in excess of 15 Kv to fire, running off a 12 volt source.
